(19) United States
(12) Patent Application Publication
(10) Pub. No.: US 2016/0210060 A1
(43) Pub. Date: Jul. 21, 2016

(54) DYNAMIC RESOURCE ALLOCATION WITHIN STORAGE DEVICES

(71) Applicant: HGST Netherlands B.V., Amsterdam (NL)

(72) Inventor: David G. Dreyer, Rochester, MN (US)

(21) Appl. No.: 14/601,912

(22) Filed: Jan. 21, 2015

(51) Int. Cl. G06F 3/06

(52) U.S. Cl. CPC G06F 3/0613; G06F 3/0608; G06F 3/0631; G06F 3/0652; G06F 3/0688

(57) ABSTRACT

In general, techniques are described for dynamic resource allocation within storage devices, such as solid-state drives (SSDs). A storage device comprising a controller may be configured to perform the techniques. The controller may be configured to determine, during a first interval of time, a host bandwidth consumed by host write requests from a host device and a garbage collection (GC) bandwidth consumed by GC write requests from a GC process. The controller may further be configured to dynamically allocate, during a second interval of time subsequent to the first interval of time, system resources to the GC process and the host device for servicing the GC write requests and the host write requests during the second interval of time based on the host bandwidth and the GC bandwidth.

### TECHNICAL FIELD

This disclosure relates to solid-state drives, and more specifically, bandwidth allocation within solid-state drives.

### BACKGROUND

Solid-state drives (SSDs) may be used in computers in applications where relatively low latency and high capacity storage are desired. For example, SSDs may exhibit lower latency, particularly for random reads and writes, than hard disk drives (HDDs). This may allow greater throughput for random reads from and random writes to a SSD compared to a HDD. Additionally, SSDs may utilize multiple, parallel data channels to read from and write to memory devices, which may result in high sequential read and write speeds.

The SSDs may utilize non-volatile memory devices, such as flash memory devices, which continue to store data without requiring persistent or periodic power supply. Flash memory devices may be written on page-basis (a page consisting of multiple cells) but erased on a block-basis (a block consisting of multiple pages). When a majority of pages in a given block become stale (in terms of storing data that is no longer needed), the SSD may perform a process referred to as “garbage collection.” During garbage collection, the SSD may relocate the valid data from the pages within the block to be erased and then erase the block to recover the stale pages. Garbage collection results in the phenomenon known as “write amplification,” where the actual amount of data written is a multiple of the amount of data requested to be written to the SSD by a host device.

In this respect, the SSD may attempt to balance write bandwidth between actual writes of data requested to be written by the host device with writes that accrue because of the relocation of data during garbage collection. Algorithms to accommodate this type of bandwidth distributions may be static, assigning equal priority to host write requests and garbage collection write requests. These static algorithms may fail however as a result of the nature of how host write request and garbage write requests are initiated. Failure of these algorithms may, when garbage collection write requests are left unattended due to large numbers of host write requests, result in a lack of available memory to accommodate the host write requests given that garbage collection has been unable to free up the stale pages.

### SUMMARY

In some examples, a method comprises determining, by a storage device, a host bandwidth as an amount of bandwidth consumed by host write requests during a first interval of time, the host write requests issues by a host device, determining, by the storage device, a garbage collection (GC) bandwidth as an amount of bandwidth consumed during the first interval of time by GC write requests, the GC write requests issued by a GC process performed by the storage device, and dynamically allocating, during a second interval of time subsequent to the first interval of time, system resources to the GC process and the host device for servicing the GC write requests and the host write requests during the second interval of time based on the host bandwidth and the GC bandwidth.

In some examples, a storage device comprises a controller configured to determine a host bandwidth as an amount of bandwidth consumed by host write requests during a first interval of time, the host write requests issues by a host device, determine, by the storage device, a garbage collection (GC) bandwidth as an amount of bandwidth consumed during the first interval of time by GC write requests, the GC write requests issued by a GC process performed by the storage device, and dynamically allocate, during a second interval of time subsequent to the first interval of time, system resources to the GC process and the host device for servicing the GC write requests and the host write requests during the second interval of time based on the host bandwidth and the GC bandwidth.

In some examples, a non-transitory computer-readable storage medium has stored thereon instructions that, when executed, cause one or more processors of a storage device to determine a host bandwidth as an amount of bandwidth consumed by host write requests during a first interval of time, the host write requests issued by a host device, determine a garbage collection (GC) bandwidth as an amount of bandwidth consumed during the first interval of time by GC write requests, the GC write requests issued by a GC process performed by the storage device, and dynamically allocate, during a second interval of time subsequent to the first interval of time, system resources to the GC process and the host device for servicing the GC write requests and the host write requests during the second interval of time based on the host bandwidth and the GC bandwidth.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic block diagram illustrating an example storage environment in which a storage device may function as a storage device for a host device, in accordance with one or more techniques of this disclosure

FIG. 2 is a conceptual and schematic block diagram illustrating an example controller, in accordance with one or more techniques of this disclosure.

FIG. 3 is a block diagram illustrating in more detail the DBA module shown in the examples of FIGS. 1 and 2.

FIG. 4 is a flowchart illustrating exemplary operation of a storage device in performing various aspects of the techniques described in this disclosure.

### DETAILED DESCRIPTION

The disclosure describes technique for dynamic bandwidth allocation within solid-state drives (SSDs). Rather than rely on a static algorithm that may accommodate a certain subset of write workloads and write amplification multipliers, the techniques may enable an SSD to dynamically adjust write bandwidth allocation to accommodate a wider variety of (and possibly all or nearly all) write workloads and write amplification multipliers. In other words, a controller of an SSD may periodically determine write bandwidth consumed over a first interval or, in other words, duration of time by each of host writes and a garbage collection (GC) process executed by the SSD for internal maintenance of non-volatile memory of the SSD.

This bandwidth consumed by host writes represents write bandwidth consumed by writes issued by a host device to which the SSD either integrates or communicates and may reflect the number of host-originated writes (which may be referred to as “host writes”) dispatched for processing by a so-called NAND processor (which may refer to an example of a memory processor for interfacing NAND-based flash memory) during the first interval of time. The bandwidth consumed by the GC process represents write bandwidth consumed by writes issued by the GC process executed by the controller and may reflect the number of GC-originated writes (which may be referred to as “GC writes”) dispatched for processing by the NAND processor during the same first interval of time. The controller may compute the host bandwidth and the GC bandwidth for each interval of time.

The controller may also dynamically determine inputs to determining the write amplification multiplier, such as a validity ratio and an invalidity ratio. The controller may dynamically determine these ratios for each interval of time. The validity ratio may refer to the amount of valid data which must be relocated during execution of the GC process during the monitored interval of time. In other words, the validity ratio may refer to the ratio of the amount of valid data in the GC unit over the total amount of data in the GC unit. The controller may compute the validity and invalidity ratios as an average across one or more intervals of time (e.g., as a so-called “rolling average”).

The controller may then dynamically allocate bandwidth based on one or more of the host bandwidth, the GC bandwidth, the validity ratio and the invalidity ratio in an attempt to assign equal amounts of bandwidth to the host device and the GC process. Reference to bandwidth allocation in this disclosure may refer to allocation of system resources during the upcoming interval of time to service GC writes and host writes. The system resources may include internal memory (data buffer which is a staging area for reads and writes to the media), CPU instruction cycles, NAND Dies, and some non-physical resource (such as a software credit pool, or entries in a queue).

In any event, this dynamic allocation may represent an attempt to equally allocate the overall write bandwidth because, during any given interval, writes may increase or decrease while the nature of the host writes in comparison to the GC writes may have varying impacts on the ability to service all of these various writes in a manner that facilitates adequate operation of the SSD. As such, the dynamical allocation may overshoot bandwidth allocation to host writes during one interval and then undershoot bandwidth allocation to host writes during a next interval (while conversely undershooting bandwidth allocation to GC writes in the one interval and then overshoot bandwidth allocation to GC writes during the next interval). The controller may however achieve equilibrium of bandwidth allocation within, as one example, one or two seconds, depending on the size of the resource pool, the interval and the size of bandwidth adjustments that occur from one interval to the next.

As a result of this dynamic bandwidth allocation, the techniques may provide for optimal host performance, as the techniques may only give the GC process as much bandwidth as is required to keep up with the host write bandwidth. As a result, mixed workloads (e.g., mixed between host and the GC process or mixed between writes and reads) perform well because there is a natural reduction in host write bandwidth, and thus a natural reduction in GC bandwidth may result, thereby giving more resources to the host. The techniques may dynamically tune write bandwidth allocation to accommodate a wide variety of SSDs deployed in a wide variety of use cases (each of which may be subject to a wide variety of workloads).

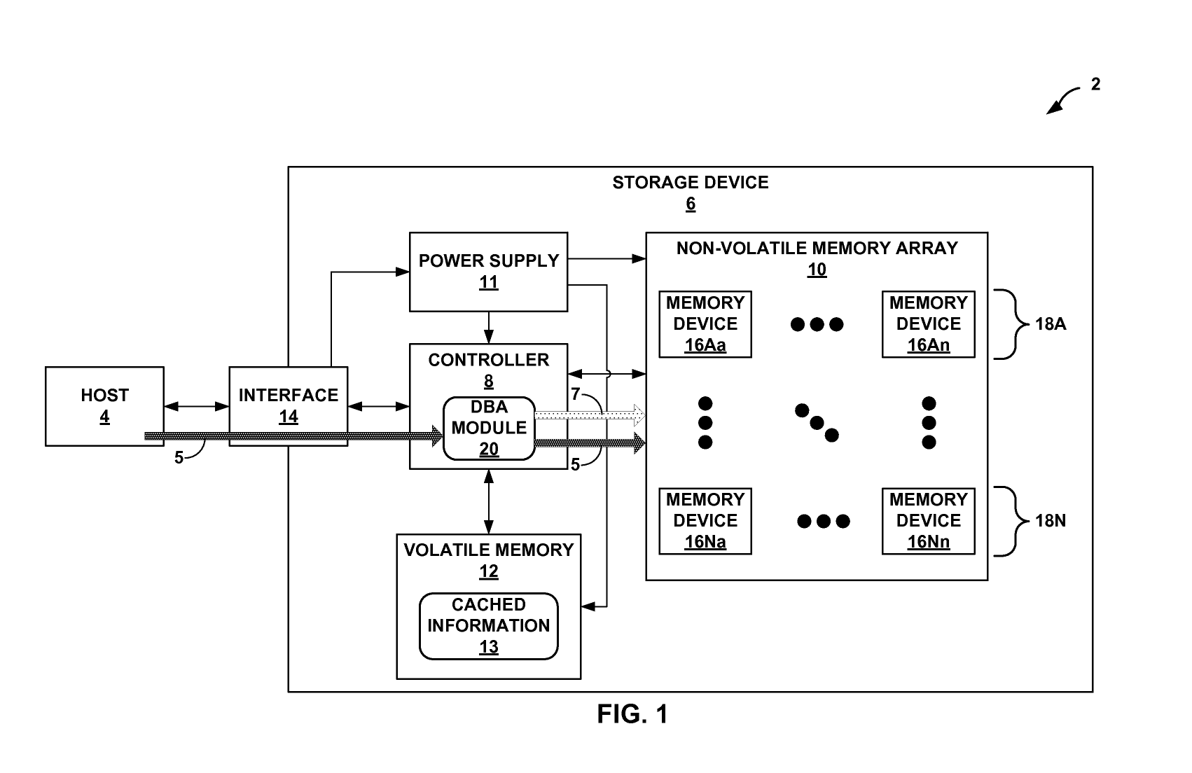

FIG. 1 is a conceptual and schematic block diagram illustrating an example storage environment 2 in which storage device 6 may function as a storage device for host device 4, in accordance with one or more techniques of this disclosure. For instance, host device 4 may utilize non-volatile memory devices included in storage device 6 to store and retrieve data. In some examples, storage environment 2 may include a plurality of storage devices, such as storage device 6, that may operate as a storage array. For instance, storage environment 2 may include a plurality of storages devices 6 configured as a redundant array of inexpensive/independent disks (RAID) that collectively function as a mass storage device for host device 4.

Storage environment 2 may include host device 4 which may store and/or retrieve data to and/or from one or more storage devices, such as storage device 6. As illustrated in FIG. 1, host device 4 may communicate with storage device 6 via interface 14. Host device 4 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like.

As illustrated in FIG. 1 storage device 6 may include controller 8, non-volatile memory array 10 (NVMA 10), power supply 11, volatile memory 12, and interface 14. In some examples, storage device 6 may include additional components not shown in FIG. 1 for the sake of clarity. For example, storage device 6 may include a printed board (PB) to which components of storage device 6 are mechanically attached and which includes electrically conductive traces that electrically interconnect components of storage device 6; and the like. In some examples, the physical dimensions and connector configurations of storage device 6 may conform to one or more standard form factors. Some example standard form factors include, but are not limited to, 3.5″ hard disk drive (HDD), 2.5″ HDD, 1.8″ HDD, peripheral component interconnect (PCI), PCI-extended (PCI-X), PCI Express (PCIe) (e.g., PCIe ×1, ×4, ×8, ×16, PCIe Mini Card, MiniPCI, etc.). In some examples, storage device 6 may be directly coupled (e.g., directly soldered) to a motherboard of host device 4.

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI), and PCI-express. The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit storage device 6 to receive power from host device 4. As illustrated in FIG. 1, power supply 11 may receive power from host device 4 via interface 14.

Storage device 6 may include NVMA 10 which may include a plurality of memory devices 16Aa-16Nn (collectively, “memory devices 16”) which may each be configured to store and/or retrieve data. For instance, a memory device of memory devices 16 may receive data and a message from controller 8 that instructs the memory device to store the data. Similarly, the memory device of memory devices 16 may receive a message from controller 8 that instructs the memory device to retrieve data. In some examples, each of memory devices 6 may be referred to as a die. In some examples, a single physical chip may include a plurality of dies (i.e., a plurality of memory devices 16). In some examples, each of memory devices 16 may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, memory devices 16 may include any type of non-volatile memory devices. Some examples, of memory devices 16 include, but are not limited to flash memory devices, phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

Flash memory devices may include NAND or NOR based flash memory devices, and may store data based on a charge contained in a floating gate of a transistor for each flash memory cell. In NAND flash memory devices, the flash memory device may be divided into a plurality of blocks which may divided into a plurality of pages. Each block of the plurality of blocks within a particular memory device may include a plurality of NAND cells. Rows of NAND cells may be electrically connected using a word line to define a page of a plurality of pages. Respective cells in each of the plurality of pages may be electrically connected to respective bit lines. Controller 6 may write data to and read data from NAND flash memory devices at the page level and erase data from NAND flash memory devices at the block level.

In some examples, it may not be practical for controller 8 to be separately connected to each memory device of memory devices 16. As such, the connections between memory devices 16 and controller 8 may be multiplexed. As an example, memory devices 16 may be grouped into channels 18A-18N (collectively, “channels 18”). For instance, as illustrated in FIG. 1, memory devices 16Aa-16Nn may be grouped into first channel 18A, and memory devices 16Na-16Nn may be grouped into N^{th} channel 18N. The memory devices 16 grouped into each of channels 18 may share one or more connections to controller 8. For instance, the memory devices 16 grouped into first channel 18A may be attached to a common I/O bus and a common control bus. Storage device 6 may include a common I/O bus and a common control bus for each respective channel of channels 18. In some examples, each channel of channels 18 may include a set of chip enable (CE) lines which may be used to multiplex memory devices on each channel. For example, each CE line may be connected to a respective memory device of memory devices 18. In this way, the number of separate connections between controller 8 and memory devices 18 may be reduced. Additionally, as each channel has an independent set of connections to controller 8, the reduction in connections may not significantly affect the data throughput rate as controller 8 may simultaneously issue different commands to each channel.

In some examples, storage device 6 may include a number of memory devices 16 selected to provide a total capacity that is greater than the capacity accessible to host device 4. This is referred to as over-provisioning. For example, if storage device 6 is advertised to include 240 GB of user-accessible storage capacity, storage device 6 may include sufficient memory devices 16 to give a total storage capacity of 256 GB. The 16 GB of storage devices 16 may not be accessible to host device 4 or a user of host device 4. Instead, the additional storage devices 16 may provide additional blocks to facilitate writes, garbage collection, wear leveling, and the like. Further, the additional storage devices 16 may provide additional blocks that may be used if some blocks wear to become unusable and are retired from use. The presence of the additional blocks may allow retiring of the worn blocks without causing a change in the storage capacity available to host device 4. In some examples, the amount of over-provisioning may be defined as p=(T-D)/D, wherein p is the over-provisioning ratio, T is the total storage capacity of storage device 2, and D is the storage capacity of storage device 2 that is accessible to host device 4.

Storage device 6 may include power supply 11, which may provide power to one or more components of storage device 6. When operating in a standard mode, power supply 11 may provide power to the one or more components using power provided by an external device, such as host device 4. For instance, power supply 11 may provide power to the one or more components using power received from host device 4 via interface 14. In some examples, power supply 11 may include one or more power storage components configured to provide power to the one or more components when operating in a shutdown mode, such as where power ceases to be received from the external device. In this way, power supply 11 may function as an onboard backup power source. Some examples of the one or more power storage components include, but are not limited to, capacitors, super capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

Controller 8 may, in this respect, represent a unit configured to interface with host device 4 and interface with non-volatile memory array 10. Controller 8 may receive commands in the form of a command stream from host device 4. These commands may conform to a standard for accessing storage devices, such as SCSI. Controller 8 may process these commands, translating the commands into the above noted messages for accessing non-volatile memory array 10. These commands may correspond to different types, such as read verify, read, write and write verify. The commands of the same type may be referred to herein as “command sub-streams.” In other words, a command sub-stream may be referred to as a read verify command sub-stream, a read command sub-stream, a write command sub-stream and a write verify command sub-stream, each of which denotes a sub-stream having commands only of the designated type (i.e., read verify, read, write, or write verify in this example). The command stream may include commands of different types and controller 8 may identify these commands of different types and arrange them into the sub-streams through queuing or any of a number of other ways.

Although not shown in FIG. 1, controller 8 may include a host processor for interfacing with host device 4 and a memory processor for interfacing with non-volatile memory array 10 (where this memory processor may also be referred to as a “NAND processor”). The host processor may comprise a general purpose processor, such as a central processing unit (CPU), or dedicated hardware, such as an application specific integrated circuit (ASIC). Likewise, the NAND processor may comprise a general purpose processor or dedicated hardware. It is assumed for purposes of illustration that the host processor represents a CPU that executes firmware and that the NAND processor is a dedicated hardware unit specifically configured to interface with non-volatile memory array 10. The techniques, however, are not limited to this specific example and should be understood to apply to any type of controller.

As noted above, storage device 6 may utilize non-volatile memory array 10, which continue to store data without requiring persistent or periodic power supply. Flash memory devices may be written on page-basis (a page consisting of multiple cells) but erased on a block-basis (a block consisting of multiple pages). When a majority of pages in a given block become stale (in terms of storing data that is no longer needed), controller 8 may perform a process referred to as “garbage collection.” During garbage collection, controller 8 may relocate the valid data from the pages within the block to be erased and then erase the block to recover the stale pages. Garbage collection results in the phenomenon known as “write amplification,” where the actual amount of data written is a multiple of the amount of data requested to be written to non-volatile memory array 10 by host device 4.

In this respect, controller 8 may attempt to balance write bandwidth allocation between actual writes of data requested to be written by host device 4 against writes that accrue because of the relocation of data during garbage collection. Algorithms to accommodate this type of bandwidth distributions may be static, assigning equal priority to host write requests and garbage collection write requests. The static algorithms may however fail as a result of the nature of how host write request and garbage write requests are initiated. Failure of these algorithms may, when garbage collection write requests are left unattended due to large numbers of host write requests, result in a lack of available memory to accommodate the host write requests given that garbage collection has been unable to free up the stale pages.

The disclosure describes technique for dynamic bandwidth allocation within storage device 6. Rather than rely on a static algorithm that may accommodate a certain subset of write workloads and write amplification multipliers, the techniques may enable storage device 6 to dynamically adjust write bandwidth allocation to accommodate a wider variety of (and possibly all or nearly all) write workloads and write amplification multipliers. Again, reference to bandwidth allocation in this disclosure may refer to allocation of system resources during the upcoming interval of time to service GC writes and host writes. The system resources may include internal memory (data buffer which is a staging area for reads and writes to the media), CPU instruction cycles, NAND Dies, and some non-physical resource (such as a software credit pool, or entries in a queue). In any event, controller 8 of storage device 6 may be configured to invoke a dynamic bandwidth allocation (DBA) module 20 (“DBA module 20”) to periodically determine write bandwidth consumed over a first interval or, in other words, duration of time by each of host writes and a garbage collection (GC) process executed by controller 8 for internal maintenance of non-volatile memory array 10.

This bandwidth consumed by host writes represents write bandwidth consumed by writes issued by host device 4 to which storage device 6 either integrates or communicates and may reflect the number of host-originated writes (which may be referred to as “host writes”) dispatched for processing by a so-called NAND processor (which may refer to an example of a memory processor for interfacing NAND-based flash memory) during the first interval of time. The host write are shown in the example of FIG. 1 as host writes 5. The bandwidth consumed by the GC process represents write bandwidth consumed by writes issued by the GC process executed by controller 8 and may reflect the number of GC-originated writes (which may be referred to as “GC writes”) dispatched for processing by the NAND processor during the same first interval of time. The GC writes are shown in the example of FIG. 1 as GC writes 7. DBA module 20 may compute the host bandwidth and the GC bandwidth for each interval of time.

DBA module 20 may also obtain the write amplification multiplier and derive or otherwise determine a validity ratio and an invalidity ratio based on the write amplification multiplier (which may also be referred to as “write amplification” in this disclosure). DBA module 20 may dynamically determine the validity and invalidity ratios for each interval of time. The validity ratio may refer to the amount of valid data which must be relocated during execution of the GC process during the monitored interval of time. DBA module 20 may compute the validity and invalidity ratios as an average across one or more intervals of time (e.g., as a so-called “rolling average”). In other words, controller 8 may determine a validity ratio and an invalidity ratio during the same first interval of time based on an amount of data that was reallocated during the GC process.

DBA module 20 may next dynamically allocate bandwidth (which again may be a function of allocation of the system resources noted above and as described below in more detail) based on one or more of the host bandwidth, the GC bandwidth, the validity ratio and the invalidity ratio in an attempt to assign equal amounts of bandwidth to host device 4 and the GC process. In other words, DBA module 20 may be configured to operate in accordance with the techniques described in this disclosure to determine a host bandwidth as an amount of write bandwidth consumed during a first interval of time by host device 4 (e.g., in terms of host writes 5), and determine a garbage collection (GC) bandwidth as an amount of overall write bandwidth consumed during the same first interval of time by the GC process performed by controller 8 (e.g., in terms of GC writes 7). DBA module 20 may dynamical allocate write bandwidth (e.g., by way of allocating the above noted system resources) during a second interval of time subsequent to the first interval of time to the host device 4 and the GC process based on the host bandwidth and the GC bandwidth (e.g., by way of granting host writes 5 and GC writes 7 in accordance with a determined ratio). In some instances, DBA module 20 may be further configured to perform this dynamic allocation based on the host bandwidth and the GC bandwidth, as noted above, but also based on one or more of the validity ratio and the invalidity ratio.

This dynamic allocation may represent an attempt to equally allocate the overall write bandwidth because, during any given interval, writes may increase or decrease while the nature of host writes 5 in comparison to GC writes 7 may have varying impacts on the ability to service all of the host writes 5 and GC writes 7 in a manner that facilitates adequate operation of storage device 6. As such, the dynamical allocation may overshoot bandwidth allocation to host writes 5 during one interval and then undershoot bandwidth allocation to host writes 5 during a next interval (while conversely undershooting bandwidth allocation to GC writes 7 in the one interval and then overshoot bandwidth allocation to GC writes 7 during the next interval).

DBA module 20 may however achieve equilibrium of bandwidth allocation between host writes 5 and GC writes 7 within, as one example, one or two seconds, depending on the size of the resource pool, the interval and the size of bandwidth adjustments that occur from one interval to the next. Thus, when performing so-called “dynamic allocation” during a first time interval, DBA module 20 may perform multiple dynamic allocations iteratively during the first time interval, monitoring the various bandwidths and determining the various ratios during sub-intervals of the first time interval so as to achieve approximate equilibrium (e.g., between +/−1-5%) of bandwidth allocation between host writes 5 and GC writes 7 given a rolling average of the write amplification multiplier or derivatives thereof, such as the validity ratio and the invalidity ratio. In this respect, the dynamic bandwidth allocation techniques may represent a feedback controlled dynamic resource allocation (in that monitoring is performed to allow for the dynamic allocation of resources).

As a result of the dynamic bandwidth allocation, the techniques may provide for optimal host performance, as the techniques may only give the GC process as much bandwidth as is required to keep up with the host write bandwidth. As a result, mixed workloads (e.g., mixed between host device 4 and the GC process or mixed between writes and reads) perform well because there is a natural reduction in host write bandwidth, and thus a natural reduction in GC bandwidth may result, thereby giving more resources to host 4. The techniques may dynamically tune write bandwidth allocation to accommodate a wide variety of SSDs deployed in a wide variety of use cases (each of which may be subject to a wide variety of workloads).

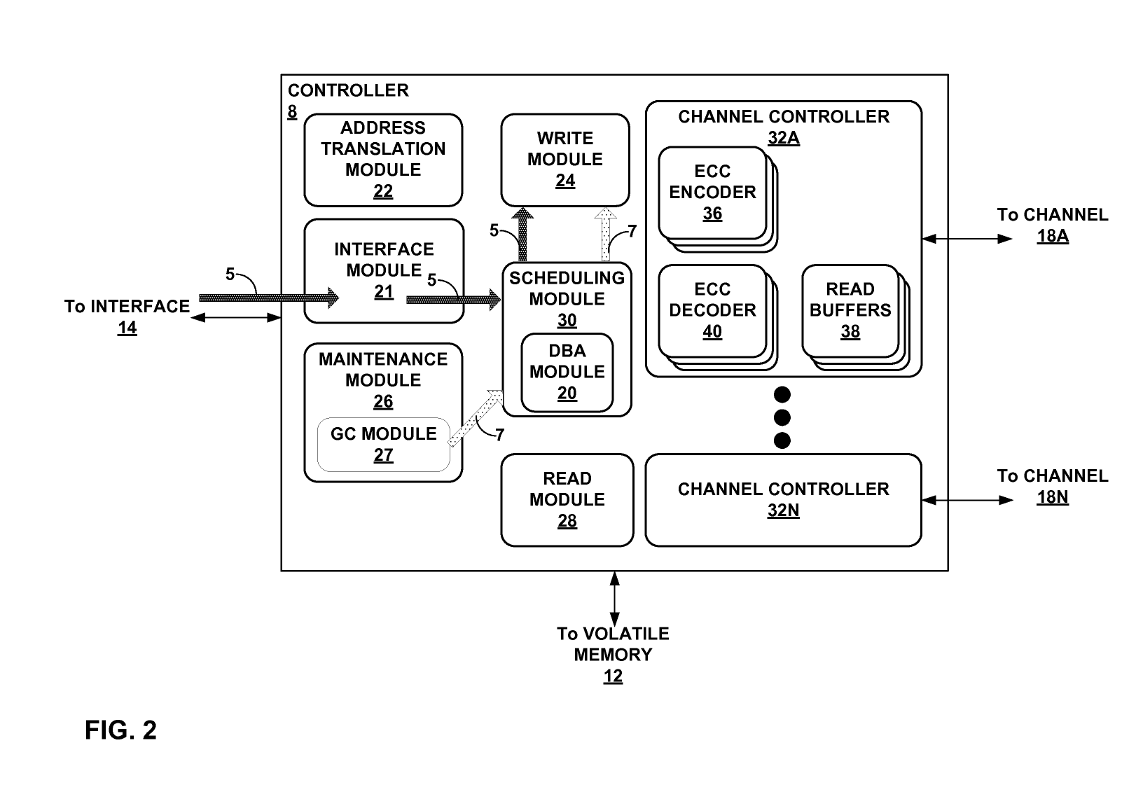

FIG. 2 is a conceptual and schematic block diagram illustrating example details of controller 8. In some examples, controller 8 may include DBA module 20, an interface module 21, an address translation module 22, a write module 24, a maintenance module 26, a read module 28, a scheduling module 30, and a plurality of channel controllers 32A-32N (collectively, “channel controllers 32”). In other examples, controller 8 may include additional modules or hardware units, or may include fewer modules or hardware units. Controller 8 may include a microprocessor, digital signal processor (DSP), application specific integrated circuit (ASIC), field programmable gate array (FPGA), or other digital logic circuitry. In some examples, controller 8 may be a system on a chip (SoC). Moreover, as noted above, controller 8 may represent one or more of the foregoing microprocessor, DSP, ASIC, FPGA, SOC or other processing controller logic in the form of a host processor and a NAND controller.

Controller 8 may interface with the host device 4 via interface 14. Interface module 21 may represent a module configured to manage the storage of data to and the retrieval of data from memory devices 16. Interface module 21 may queue commands forming command stream 19 and allocate commands to other modules, such as write module 24 via DBA module 20 and read module 28 via a dispatch queue.

Write module 24 of controller 8 may manage writes to memory devices 16. For example, write module 24 may receive a message from host device 4 via interface 14 instructing storage device 6 to store data associated with a logical address and the data. Write module 24 may manage writing of the data to memory devices 16. For example, write module 24 may communicate with address translation module 22, which manages translation between logical addresses used by host device 4 to manage storage locations of data and physical block addresses used by write module 24 to direct writing of data to memory devices.

Address translation module 22 of controller 8 may utilize a flash translation layer or table that translates logical addresses (or logical block addresses) of data stored by memory devices 16 to physical block addresses of data stored by memory devices 16. For example, host device 4 may utilize the logical block addresses of the data stored by memory devices 16 in instructions or messages to storage device 6, while write module 24 utilizes physical block addresses of the data to control writing of data to memory devices 16. (Similarly, read module 28 may utilize physical block addresses to control reading of data from memory devices 16.) The physical block addresses correspond to actual, physical blocks of memory devices 16. In some examples, address translation module 22 may store the flash translation layer or table in volatile memory 12, such as within cached information 13.

In this way, host device 4 may be allowed to use a static logical block address for a certain set of data, while the physical block address at which the data is actually stored may change. Address translation module 22 may maintain the flash translation layer or table to map the logical block addresses to physical block addresses to allow use of the static logical block address by the host device 4 while the physical block address of the data may change, e.g., due to wear leveling, garbage collection, or the like.

As discussed above, write module 24 of controller 8 may perform one or more operations to manage the writing of data to memory devices 16. For example, write module 24 may manage the writing of data to memory devices 16 by selecting one or more blocks within memory devices 16 to store the data and causing memory devices of memory devices 16 that include the selected blocks to actually store the data. As discussed above, write module 24 may cause address translation module 22 to update the flash translation layer or table based on the selected blocks. For instance, write module 24 may receive a message (i.e., one of host writes 5 in the example of FIG. 2) from host device 4 that includes a unit of data and a logical block address, select a block within a particular memory device of memory devices 16 to store the data, cause the particular memory device of memory devices 16 to actually store the data (e.g., via a channel controller of channel controllers 32 that corresponds to the particular memory device), and cause address translation module 22 to update the flash translation layer or table to indicate that the logical block address corresponds to the selected block within the particular memory device.

In some examples, after receiving the unit of data from host device 4, write module 24 may utilize volatile memory 12 to temporarily store the unit of data prior to causing one or more of memory devices 16 to actually store the data. In some examples, write module 24 may be configured to send host device 4 a message indicating whether the data was successfully stored. However, in some examples, write module 24 may send the message to host device 4 confirming successful storage of the data before the data is actually stored. For instance, write module 24 may send the message to host device 4 confirming successful storage of the data when the data is stored in volatile memory 12.

In some examples, in addition to causing the data to be stored by memory devices 16, write module 24 may cause memory devices 16 to store information which may be used to recover the unit of data should one or more of the blocks fail or become corrupted. The parity information may be used to recover the data stored by other blocks. In some examples, the parity information may be an XOR of the data stored by the other blocks.

In order to write a bit with a logical value of 0 (charged) to a bit with a previous logical value of 1 (uncharged), a large current is used. This current may be sufficiently large that it may cause inadvertent changes to the charge of adjacent flash memory cells. To protect against inadvertent changes, an entire block of flash memory cells may be erased to a logical value of 1 (uncharged) prior to writing any data to cells within the block. As a result, flash memory cells may be erased at the block level and written at the page level.

Thus, to write even an amount of data that would consume less than one page, controller 8 may cause an entire block to be erased. This may lead to write amplification, which refers to the ratio between the amount of data received from host device 4 to be written to memory devices 16 and the amount of data actually written to memory devices 16. Write amplification contributes to faster wearing of the flash memory cells than would occur with no write amplification. Wear to flash memory cells may occur when flash memory cells are erased due to the relatively high voltages used to erase the flash memory cells. Over a plurality of erase cycles, the relatively high voltages may result in changes to the flash memory cells. Eventually, the flash memory cells may become unusable due to the wear such that the flash memory cells may be unable to store data with sufficient accuracy to permit the data to be retrieved.

One process that controller 8 may implement to reduce write amplification and wear of flash memory cells includes writing data received from host device 4 to unused blocks or partially used blocks. For example, if host device 4 sends data to storage device 6 that includes only a small change from data already stored by storage device 6. The controller then may mark the old data as stale or no longer valid. Over time, this may reduce a number of erase operations blocks are exposed to, compared to erasing the block that holds the old data and writing the updated data to the same block.

Responsive to receiving a write command (shown as host writes 5 in the example of FIG. 2) from host device 4, write module 24 may determine at which physical locations (e.g., blocks) of memory devices 16 to write the data. For example, write module 24 may request from address translation module 22 or maintenance module 26 one or more physical block addresses that are empty (e.g., store no data), partially empty (e.g., only some pages of the block store data), or store at least some invalid (or stale) data. Upon receiving the one or more physical block addresses, write module 24 may select one or more block as discussed above, and communicate a message that causes channel controllers 32A-32N (collectively, “channel controllers 32”) to write the data to the selected blocks.

Read module 28 similarly may control reading of data from memory devices 16. For example, read module 28 may receive a message from host device 4 requesting data with an associated logical block address. Address translation module 22 may convert the logical block address to a physical block address using the flash translation layer or table. Read module 28 then may control one or more of channel controllers 32 to retrieve the data from the physical block addresses. Similar to write module 24, read module 28 may select one or more blocks and communicate a message to that causes channel controllers 32 to read the data from the selected blocks.

Each channel controller of channel controllers 32 may be connected to a respective channel of channels 18. In some examples, controller 8 may include the same number of channel controllers 32 as the number of channels 18 of storage device 2. Channel controllers 32 may perform the intimate control of addressing, programming, erasing, and reading of memory devices 16 connected to respective channels, e.g., under control of write module 24, read module 28, and/or maintenance module 26.

Furthermore, although shown only with respect to channel controller 32A for ease of illustration purposes, each of channel controllers 32 may include a number of exemplary resources in the form of ECC encoders 36, read buffers 38 and ECC decoders 40 similar to that shown with respect to channel controller 32A. ECC encoders 36 may represent a unit or module configured to perform ECC encoding to data waiting to be written to non-volatile memory area 10. Read buffers 38 represent a unit or module configured to store data read from non-volatile memory area 10. Read buffers 38 may be configured to store read codewords. ECC decoders 40 may represent a unit or module configured to perform ECC decoding with respect to data stored to read buffers 38.

Maintenance module 26 may be configured to perform operations related to maintaining performance and extending the useful life of storage device 6 (e.g., memory devices 16). For example, maintenance module 26 may implement at least one of wear leveling or garbage collection.

As described above, erasing flash memory cells may use relatively high voltages, which, over a plurality of erase operations, may cause changes to the flash memory cells. After a certain number of erase operations, flash memory cells may degrade to the extent that data no longer may be written to the flash memory cells, and a block including those cells may be retired (no longer used by controller 8 to store data). To increase the amount of data that may be written to memory devices 16 before blocks are worn and retired, maintenance module 26 may implement wear leveling.

In wear leveling, maintenance module 26 may track a number of erases of or writes to a block or a group of blocks, for each block or group of blocks. Maintenance module 26 may cause incoming data from host device 4 to be written to a block or group of blocks that has undergone relatively fewer writes or erases, to attempt to maintain the number of writes or erases for each block or group of blocks approximately equal. This may cause each block of memory devices 16 to wear out at approximately the same rate, and may increase the useful lifetime of storage device 6.

Although this may reduce write amplification and wear of flash memory cells by reducing a number of erases and writing data to different blocks, this also may lead to blocks including some valid (fresh) data and some invalid (stale) data. To overcome this fresh data/stale data state, maintenance module 26 may implement garbage collection. In the example of FIG. 2, maintenance module 26 includes a garbage collection (GC) module 27 (“GC module 27”), which may represent a module configured to perform the garbage collection process. During the garbage collection process, GC module 27 may analyze the contents of the blocks of memory devices 16 to determine a block that contain a high percentage of invalid (stale) data. GC module 27 may rewrite the valid data from the block to a different block by issues GC writes 7, and then erase the block. This may reduce an amount of invalid (stale) data stored by memory devices 16 and increase a number of free blocks, but also may increase write amplification and wear of memory devices 16.

Scheduling module 30 of controller 8 may perform one or more operations to schedule activities to be performed by memory devices 16. For instance, scheduling module 30 may schedule requests received from other components of controller 8 to command one or more of memory devices 16 to perform one or more activities during run-time. In some examples, scheduling module 30 may schedule the requests to be performed in the order in which they were received (e.g., first-in first-out or FIFO). In some examples, scheduling module 30 may schedule the requests based one or more factors which may include, but are not limited to, the type of request (e.g., a read request, a write request, an erase request, a garbage collection write request, etc.), an amount of time elapsed since the request was received, an amount of power that would be consumed by performance of the request, bandwidth considerations, and the like.

In some examples, such as to comply with a power consumption budget, scheduling module 30 may schedule activities to be performed such that performance is throttled. For instance, where the power consumption budget allocates an amount of power to memory devices 16 that is less than an amount of power that would be consumed if all of memory devices 16 were concurrently active, scheduling module 30 may schedule activities to be performed such that the amount of power consumed by memory devices 16 does not exceed to amount of power allocated to memory devices 16.

As one example, where storage device 6 has a power consumption target of 25 W, the power consumption budget may allocate a portion of the power consumption target (e.g., 16 W) for use by memory devices 16. If the amount of power that would be consumed if all of memory devices 16 were concurrently active is greater than the allocated portion of the power consumption target (e.g., 16 W), scheduling module 30 may determine a quantity of memory devices 16 that may be currently active without consuming more power than the allocated portion. For instance, where memory devices 16 are allocated X units of a power consumption budget and each memory device of memory devices 16 consumed one unit of power when active, scheduling module 30 may determine that X memory devices of memory devices 16 may be concurrently active.

In some examples, scheduling module 30 may be configured to selectively enable the performance throttling. For instance, scheduling module 30 may enable throttling when operating in a first mode and disable throttling when operating in a second mode. In some examples, such as where throttling reduces the amount of memory devices 16 that may be concurrently active, the rate at which scheduling module 30 may cause data may be written to memory devices 16 may be lower in when throttling is enabled as compared to when throttling is disabled.

As also shown in the example of FIG. 2, scheduling module 30 may include DBA module 20 that may be configured to perform various aspects of the techniques described in this disclosure. DBA module 20 may, in other words, perform bandwidth arbitration via what may be referred to as a “feedback control.” DBA module 20 may perform a dynamic bandwidth allocation algorithm that is based on the following equation (1):

HostBandwidth*ValidityRatio=GCBandwidth*InvalidityRatio (1)

In the foregoing equation, the variable HostBandwidth represents to write bandwidth consumed by host writes 5 over a first interval of time. The variable ValidityRatio represents to the above described validity ratio. The variable GCBandwidth represents the write bandwidth consumed by GC writes 7 over the same first interval of time. The variable InvalidityRatio represents the above described invalidity ratio.

The HostBandwidth and GCBandwidth variables may, stated differently, represent a measure of the actual host writes 5 and GC writes 7 that DBA module 20 has scheduled to the NAND processor (e.g., which may be represented in part as write module 24). The ValidityRatio and InvalidityRatio variables may represent variables based on write amplification. The ValidityRatio variable may represent the amount of valid data that is reallocated during the GC process as performed by GC module 27 during the first interval of time. A validity ratio of 50% may result in a write amplification of two (2). DBA module 20 may obtain the ValidityRatio and InvalidityRatio in accordance with the following equations (2) and (3):

WA=1/InvalidityRatio; and (2)

ValidityRatio=1−InvalidityRatio. (3)

The variable WA represents a measure of the write amplification. GC module 27 may measure the write amplification multiplier and provide the write amplification multiplier to DBA module 20 in the form of the WA variable. From this WA variable, DBA module 20 may compute the InvalidityRatio and the ValidityRatio. In this way, DBA module 20 may determining a validity ratio and an invalidity ratio during the first interval of time based on an amount of data that was reallocated during the GC process performed by GC module 27.

When equation (1) is satisfied, DBA module 20 may perform dynamic bandwidth allocation and potentially achieve equilibrium in terms of write bandwidth allocation. The term “equilibrium” in the context may refer to a situation in which host writes 5 and GC writes 7 are mixed such that the total free space is not changing (or only negligibly changing) on a macro level. DBA module 20 may determine that there is some resource allocation that may allow for this equation to be satisfied, but may not determine this allocation given the dynamic nature of host writes 5 and that GC writes 7 may be dependent on GC read. In the context of bandwidth arbitration, the effect of the GC read may be a result of the latency of the NAND read, which can range from 100 μs to 2 ms. As a result, DBA module 20 may adjust the write bandwidth allocation between host writes 5 and GC writes 7, using a coarse adjustment when there are large disparities in host bandwidth and GC bandwidth and finer adjustments when there are relatively smaller disparities in host write bandwidth and GC write bandwidth.

For example, DBA module 20 may perform this feedback control algorithm to dynamically arbitrate write bandwidth allocation during a second interval of time between host device 4 and GC process 7 as outlined below:

For each fixed interval of time (such as 128 or 256 milliseconds (ms)):
Snapshot the current HostBandwidth and GCBandwidth which has accumulated over the last interval of time (which may represent the above denoted first interval of time).
Multiply each of the HostBandwidth and the GCBandwidth by the respective ValidityRatio and the InvalidityRatio, which may be determined based on a rolling average of the write amplification. The HostBandwidth multiplied by the ValidityRatio may be denoted the “modifiedHostBandwidth,” while the GCBandwidth multiplied by the InvalidityRatio may be denoted the “modifiedGCBandwidth.”
Determine a so-called “write bandwidth ratio” as a function of the modifiedHostBandwidth and the modifiedGCBandwidth, where this write bandwidth ratio may be close to 1 when the system is in equilibrium.
Determine, based on the bandwidth ratio, an adjustment to be made to HostBandwidth & GCBandwidth to maintain or otherwise reduce inequality in bandwidth allocation between HostBandwidth and GCBandwidth. When the bandwidth ratio is large, apply a coarse adjustment to the resource thresholds, otherwise, apply a fine adjustment, or no adjustment.
   DBA module 20 may repeat this for each interval of time and continue to adapt to changing workloads, write amplification and other conditions. DBA module 20, by performing this feedback control algorithm, may determine a resource allocation that reaches equilibrium or near equilibrium in host bandwidth and GC bandwidth. As noted above, identifying the resource allocation that reaches equilibrium may take 1-2 seconds depending on the size of the resource pool, the interval of time, and the size of the coarse and fine adjustment.

In this respect, DBA module 20 may be configured to dynamically allocate the write bandwidth by, at least in part, multiply the host bandwidth by the validity ratio to determine a modified host bandwidth for the first interval of time, and multiply the GC bandwidth by the invalidity ratio to determine a modified GC bandwidth for the first interval of time. DBA module 20 may next determine a write bandwidth ratio for the first interval of time as a function of the modified host bandwidth and the modified GC bandwidth, and allocate system resources for writes during the second interval of time to the host device and the GC process based on the write bandwidth ratio determined for the first interval of time. DBA module 20 may, in some examples, dynamically allocate the write bandwidth during the second interval of time to host 4 and GC module 27 based on a difference between the write bandwidth ratio and one (1).

DBA module 20 may, as noted above, determine the host bandwidth based on one or more write requests 5 from the host 4 scheduled to the non-volatile memory 10 during the first interval of time. DBA module 20 may further determine the GC bandwidth based on one or more write requests 7 from the GC module 27 scheduled to the non-volatile memory 10 during the first interval of time.

DBA module 20, once the resource allocation for host 4 and GC module 27 are determined, service, during the second interval of time, write requests 5 from host 5 in accordance with the write bandwidth allocated to host 4, and service write requests 7 from GC module 27 in accordance with the write bandwidth allocated to GC module 27. DBA module 20 may, in this respect, dynamically allocating the write bandwidth during the second interval of time to host 5 and GC module 27 based on the host bandwidth and the GC bandwidth so as to reach equilibrium in terms of bandwidth use by host 5 and GC module 27.

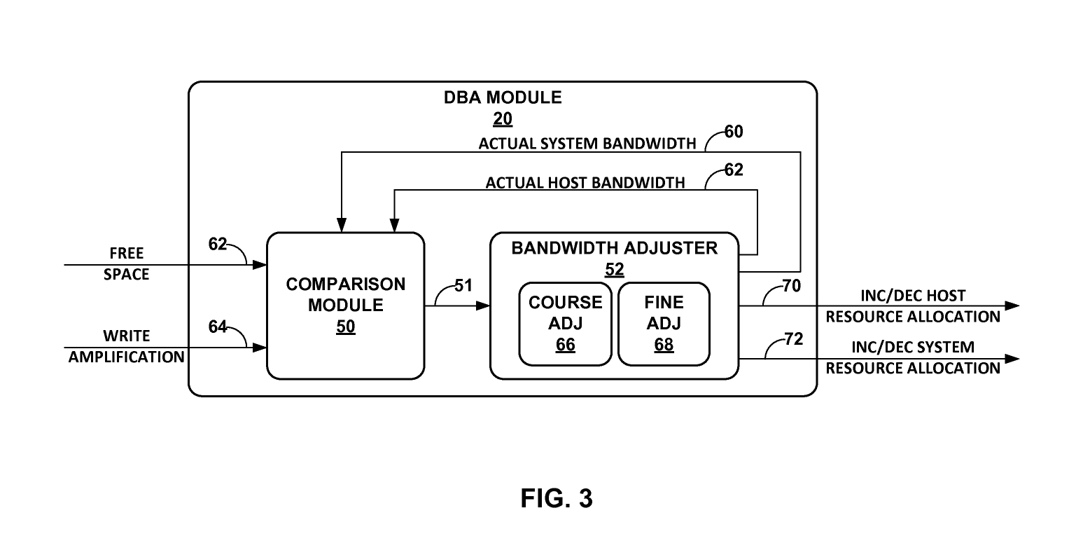

FIG. 3 is a block diagram illustrating in more detail DBA module 20 shown in the examples of FIGS. 1 and 2. In the example of FIG. 3, DBA module 20 includes a comparison module 50 and a bandwidth adjuster module 52. The comparison module 50 may represent a unit configured to perform the above noted comparison of actual system bandwidth 60 and actual host bandwidth 62 to an expected system bandwidth and an expected host bandwidth. Actual system bandwidth 60 may refer to write bandwidth allocated to GC module 27. Actual host bandwidth 62 may refer to write bandwidth allocated to host 4. The expected system bandwidth may refer to write bandwidth expected to be allocated to GC module 27, while the expected host bandwidth may refer to write bandwidth expected to be allocated to host 4. Comparison module 50 may derive or otherwise obtain the expected system bandwidth and the expected host bandwidth based on a write amplification 66 provided by GC module 27 or more generally by maintenance module 26 in the manner described above. Comparison module 50 may provide an indication 51 indicating whether equilibrium is achieved or not to bandwidth adjuster module 52. Comparison module 50 may determine that equilibrium is achieved based on free space 62 provided by maintenance module 26 as described above.

Bandwidth adjuster module 52 may adjust write bandwidth (or other resources) in accordance with indication from comparison module 50. When indication 51 indicates that equilibrium is achieved, bandwidth adjuster module 52 may not modify the existing resource allocation. However, when indication 51 indicates that equilibrium is not achieved, bandwidth adjuster 52 may apply a course adjustment 66 (“course adj 66”) or a fine adjustment 68 (“fine adj 68”) to the existing resource allocations. Indication 51 may also indicate a degree of imbalance in the write bandwidth allocation between host 4 and GC module 27 (or more generally the system) in the form, for example, of a ratio. Bandwidth adjuster module 52 may compare this degree of imbalance to a value, such as one, to determine whether to apply course adjustment 66 or fine adjustment 68 to the existing resource allocation.

Bandwidth adjuster 52 may output an increment/decrement host resource allocation signal 70 and an increment/decrement system resource allocation signal 72 to scheduling module 30. The increment/decrement host resource allocation signal 70 may be determined as a function of the course adjustment 66 or the fine adjustment 68 with the sign (e.g., whether to increment or decrement) determined as a function of the degree of imbalance. Likewise, the increment/decrement system resource allocation signal 72 may be determined as a function of the course adjustment 66 or the fine adjustment 68 with the sign (e.g., whether to increment or decrement) determined as a function of the degree of imbalance. Scheduling module 30 may then adjust the allocation of write bandwidth based on the increment/decrement host resource allocation signal 70 and the increment/decrement system resource allocation signal 72.

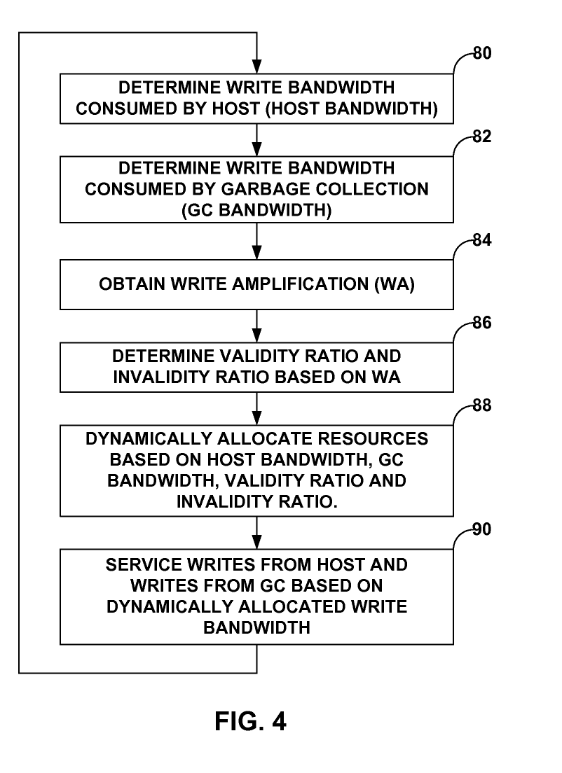

FIG. 4 is a flowchart illustrating exemplary operation of a storage device in performing various aspects of the techniques described in this disclosure. For example, controller 8 of storage device 6 shown in the example of FIG. 2 may be configured to invoke a dynamic bandwidth allocation (DBA) module 20 (“DBA module 20”) to perform the dynamic bandwidth allocation techniques described in this disclosure. DBA module 20 may periodically determine write bandwidth consumed over a first interval or, in other words, by each of host writes and a garbage collection (GC) process executed by controller 8 for internal maintenance of non-volatile memory array 10 (80, 82).

DBA module 20 may also obtain the write amplification multiplier and derive or otherwise determine a validity ratio and an invalidity ratio based on the write amplification, as described above (84, 86). DBA module 20 may next dynamically allocate bandwidth based on one or more of the host bandwidth, the GC bandwidth, the validity ratio and the invalidity ratio in an attempt to assign equal amounts of bandwidth to host device 4 and the GC process (88). Scheduler module 30 may service writes 5 from host 4 and writes 7 from GC module 27 in accordance with the dynamically allocated write bandwidth as described above (90). The foregoing process may be repeated over fluctuating intervals of time, fixed intervals of time (which may be referred to as periodically), only upon reaching a certain threshold of free space within non-volatile memory 10 or based on any other common contingent (e.g., when power is above a certain threshold, etc.) (80-90).

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
determining, by a storage device, a host bandwidth as an amount of bandwidth consumed by host write requests during a first interval of time, the host write requests issues by a host device;
determining, by the storage device, a garbage collection (GC) bandwidth as an amount of bandwidth consumed during the first interval of time by GC write requests, the GC write requests issued by a GC process performed by the storage device; and
dynamically allocating, during a second interval of time subsequent to the first interval of time, system resources to the GC process and the host device for servicing the GC write requests and the host write requests during the second interval of time based on the host bandwidth and the GC bandwidth.

2. The method of claim 1, further comprising:
determining a validity ratio and an invalidity ratio during the first interval of time based on an amount of data that was reallocated during the GC process;
wherein dynamically allocating the system resources comprises dynamically allocating the system resources based on the host bandwidth, the GC bandwidth, the validity ratio and the invalidity ratio.

3. The method of claim 2, wherein determining the validity ratio and the invalidity ratio comprises updating a rolling average of the validity ratio and a rolling average of the invalidity ratio to determine the validity ratio and the invalidity ratio during the first interval of time.

4. The method of claim 2, wherein dynamically allocating the write bandwidth comprises:
multiplying the host bandwidth by the validity ratio to determine a modified host bandwidth for the first interval of time;
multiplying the GC bandwidth by the invalidity ratio to determine a modified GC bandwidth for the first interval of time;
determining a write bandwidth ratio for the first interval of time as a function of the modified host bandwidth and the modified GC bandwidth; and
allocating the system resources during the second interval of time to the host device and the GC process based on the write bandwidth ratio determined for the first interval of time.

5. The method of claim 4, wherein dynamically allocating the system resources comprises dynamically allocating the system resources during the second interval of time to the host device and the GC process based on a difference between the write bandwidth ratio and one (1).

6. The method of claim 1,
wherein determining the host bandwidth comprises determining the host bandwidth based on the host write requests from the host device scheduled to the non-volatile memory during the first interval of time; and
wherein determining the GC bandwidth comprises determining the GC bandwidth based on the GC write requests from the GC process scheduled to the non-volatile memory during the first interval of time.

7. The method of claim 1, further comprising:
during the second interval of time, servicing the host write requests from the host device in accordance with the system resources allocated to the host device; and
during the second interval of time, servicing the GC write requests from the GC process in accordance with the system resources allocated to the GC process.

8. The method of claim 1, wherein dynamically allocating the system resources comprises dynamically allocating the system resources during the second interval of time to the host device and the GC process based on the host bandwidth and the GC bandwidth so as to reach equilibrium in terms of bandwidth use by the host device and the GC process.

9. The method of claim 1, wherein dynamically allocating the system resources comprises:
dynamically incrementing or decrementing allocation of the system resources by a fine amount or a course amount to the host device based on the host bandwidth and the GC bandwidth; and
dynamically decrementing or incrementing allocation of the system resources by the fine amount or the course amount to the GC process based on the host bandwidth and the GC bandwidth.

10. The method of claim 1, wherein the storage device comprises a solid-state drive (SSD).

11. A storage device comprising:
a controller configured to determine a host bandwidth as an amount of bandwidth consumed by host write requests during a first interval of time, the host write requests issues by a host device, determine, by the storage device, a garbage collection (GC) bandwidth as an amount of bandwidth consumed during the first interval of time by GC write requests, the GC write requests issued by a GC process performed by the storage device, and dynamically allocate, during a second interval of time subsequent to the first interval of time, system resources to the GC process and the host device for servicing the GC write requests and the host write requests during the second interval of time based on the host bandwidth and the GC bandwidth.

12. The storage device of claim 11,
wherein the controller is further configured to determine a validity ratio and an invalidity ratio during the first interval of time based on an amount of data that was reallocated during the GC process, and
wherein the controller is configured to dynamically allocate the system resources based on the host bandwidth, the GC bandwidth, the validity ratio and the invalidity ratio.

13. The storage device of claim 12, wherein the controller is configured to update a rolling average of the validity ratio and a rolling average of the invalidity ratio to determine the validity ratio and the invalidity ratio during the first interval of time.

14. The storage device of claim 12, wherein the controller is configured to multiply the host bandwidth by the validity ratio to determine a modified host bandwidth for the first interval of time, multiply the GC bandwidth by the invalidity ratio to determine a modified GC bandwidth for the first interval of time, determine a write bandwidth ratio for the first interval of time as a function of the modified host bandwidth and the modified GC bandwidth, and allocate the system resources during the second interval of time to the host device and the GC process based on the write bandwidth ratio determined for the first interval of time.

15. The storage device of claim 14, wherein the controller is configured to dynamically allocate the system resources during the second interval of time to the host device and the GC process based on a difference between the write bandwidth ratio and one (1).

16. The storage device of claim 11,
wherein the controller is configured to determine the host bandwidth based on the host write requests from the host device scheduled to the non-volatile memory during the first interval of time, and
wherein the controller is configured to determine the GC bandwidth based on the GC write requests from the GC process scheduled to the non-volatile memory during the first interval of time.

17. The storage device of claim 11, wherein the controller is further configured to, during the second interval of time, service the host write requests from the host device in accordance with the system resources allocated to the host device, and during the second interval of time, service the GC write requests from the GC process in accordance with the system resources allocated to the GC process.

18. The storage device of claim 11, wherein the controller is configured to dynamically allocate the system resources during the second interval of time to the host device and the GC process based on the host bandwidth and the GC bandwidth so as to reach equilibrium in terms of bandwidth use by the host device and the GC process.

19. The storage device of claim 11, wherein the controller is configured to dynamically increment or decrement allocation of the system resources by a fine amount or a course amount to the host device based on the host bandwidth and the GC bandwidth, and dynamically decrement or increment allocation of the system resources by the fine amount or the course amount to the GC process based on the host bandwidth and the GC bandwidth.

20. The storage device of claim 11, wherein the storage device comprises a solid-state drive (SSD).

21. A non-transitory computer-readable storage medium having stored thereon instructions that, when executed, cause one or more processors of a storage device to:
determine a host bandwidth as an amount of bandwidth consumed by host write requests during a first interval of time, the host write requests issued by a host device;
determine a garbage collection (GC) bandwidth as an amount of bandwidth consumed during the first interval of time by GC write requests, the GC write requests issued by a GC process performed by the storage device; and
dynamically allocate, during a second interval of time subsequent to the first interval of time, system resources to the GC process and the host device for servicing the GC write requests and the host write requests during the second interval of time based on the host bandwidth and the GC bandwidth.

22. The non-transitory computer readable storage medium of claim 21, wherein the instructions further cause the one or more processors to:
update a rolling average of a validity ratio and a rolling average of an invalidity ratio to determine the validity ratio and the invalidity ratio during the first interval of time;
multiply the host bandwidth by the validity ratio to determine a modified host bandwidth for the first interval of time;
multiply the GC bandwidth by the invalidity ratio to determine a modified GC bandwidth for the first interval of time;
determine a write bandwidth ratio for the first interval of time as a function of the modified host bandwidth and the modified GC bandwidth; and
allocate the system resources during the second interval of time to the host device and the GC process based on the write bandwidth ratio determined for the first interval of time.
